(19) United States
(12) Patent Application Publication
(10) Pub. No.: US 2022/0007219 A1
(43) Pub. Date: Jan. 6, 2022

(54) TRACE MANAGEMENT

(71) Applicant: NOKIA SOLUTIONS AND NETWORKS OY, Espoo (FI)

(72) Inventors: Jing PING, Chengdu (CN); Anatoly ANDRIANOV, Schaumburg, IL (US)

(73) Assignee: NOKIA SOLUTIONS AND NETWORKS OY, Espoo (FI)

(21) Appl. No.: 17/293,562

(22) PCT Filed: Nov. 14, 2018
(86) PCT No.: PCT/CN2018/115332

§ 371 Date: May 13, 2021

(51) Int. Cl. H04W 24/08; H04W 24/10; H04L 12/26; H04W 76/10; H04W 24/02

(52) U.S. Cl. CPC H04W 24/08; H04W 24/10; H04L 41/04; H04W 76/10; H04W 24/02; H04L 43/10

(57) ABSTRACT

A method of object management comprises on a managed object instance, in response to receiving a request for a trace session from a trace user, determining the trace session associated with the managed object instance; generating a trace recording session in the trace session, the trace recording session indicating an event occurring after the request is received, the trace recording session being associated with the trace session; generating a trace record at least partially based on trace message in the trace recording session, the trace record being associated with the trace recording session; and generating a trace report at least partially based on the trace record, the trace report being associated with the managed object instance. In this way, the duty of the management plane and control/signalling plane will be separated and the architecture and interaction between management entities and network functions will be simplified.

### FIELD

Embodiments of the present disclosure generally relate to the field of telecommunication and in particular, to the trace management.

### BACKGROUND

Currently, the trace management specification of Third Generation Partnership Project Services and System Aspects Work Group 5 (3GPP SA5) specifies trace session management and control, trace data content, trace file format and trace reporting procedures across Element Managers (EMs), Network Elements (NEs) and Trace Collection Entity (TCE). To centralize trace session control and trace reporting management, SA5 further specifies a Trace Integration Reference Point (IRP) to manage and control trace job from IRPManager in Network Manager (NM) to IRPAgent in EM.

This specific interface and tightly coupled design pattern is incompatible with Services Based Management Architecture (SBMA) management paradigm that 3GPP SA5 introduced for 5G management in 3GPP Release 15. The mechanism limited the management capability across multiple layers. In addition, although the current mechanism of the trace management is a smart way to convey trace management information on signaling plane, it also introduces complicity and potential security and availability issues.

### SUMMARY

In general, example embodiments of the present disclosure provide a solution for trace management.

In a first aspect, there is provided a method for trace management. The method comprises on a managed object instance, in response to receiving a request for a trace session from a trace user, determining the trace session associated with the managed object instance; generating a trace recording session in the trace session, the trace recording session indicating an event occurring after the request is received, the trace recording session being associated with the trace session; generating a trace record at least partially based on trace message in the trace recording session, the trace record being associated with the trace recording session; and generating a trace report at least partially based on the trace record, the trace report being associated with the managed object instance.

In a second aspect, there is provided an apparatus for trace management. The apparatus comprises at least one processor; and at least one memory including computer program codes; the at least one memory and the computer program codes are configured to, with the at least one processor, cause the apparatus at least to perform the method according to the first aspect.

In a third aspect, there is provided an apparatus for trace management. The apparatus comprises means to perform the steps of the method according to the first aspect.

In a fourth aspect, there is provided a computer readable medium having instructions stored thereon. The instructions, when executed on at least one processor of a device, cause the device to carry out the method according to the first aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 shows a conventional network management system 100;

FIG. 2 shows a process 200 for trace management based on the conventional network management system of FIG. 1;

FIG. 3 shows an example network management system 300 in which embodiments of the present disclosure may be implemented;

FIG. 4 shows an example process 400 for trace management according to some example embodiments of the present disclosure;

FIG. 5 shows a diagram of class in the Network Resource Model based trace management;

FIG. 6 shows a flowchart of an example method 600 for trace management according to some example embodiments of the present disclosure;

FIG. 7 shows a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:

(a) hardware-only circuit implementations (such as implementations in only analog and/or digital circuitry) and

(b) combinations of hardware circuits and software, such as (as applicable):

(i) a combination of analog and/or digital hardware circuit(s) with software/firmware and

(ii) any portions of hardware processor(s) with software (including digital signal processor(s)), software, and memory(ies) that work together to cause an apparatus, such as a mobile phone or server, to perform various functions) and

(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “wireless communication network” refers to a network following any suitable wireless communication standards, such as New Radio (NR), Long Term Evolution (LTE), LTE-Advanced (LTE-A), Wideband Code Division Multiple Access (WCDMA), High-Speed Packet Access (HSPA), and so on. The “wireless communication network” may also be referred to as a “wireless communication system.” Furthermore, communications between network devices, between a network device and a terminal device, or between terminal devices in the wireless communication network may be performed according to any suitable communication protocol, including, but not limited to, Global System for Mobile Communications (GSM), Universal Mobile Telecommunications System (UMTS), Long Term Evolution (LTE), New Radio (NR), European Telecommunications Standards Institute (ETSI), wireless local area network (WLAN) standards, such as the IEEE 802.11 standards, and/or any other appropriate wireless communication standard either currently known or to be developed in the future.

As used herein, the term “network device” refers to a node in a communication network via which a terminal device accesses the network and receives services therefrom. The network device may also refer to a network device, an access network node, a base station (BS), or an access point (AP), for example, a node B (NodeB or NB), an evolved NodeB (eNodeB or eNB), a Home Node B, a Home eNode B, a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like.

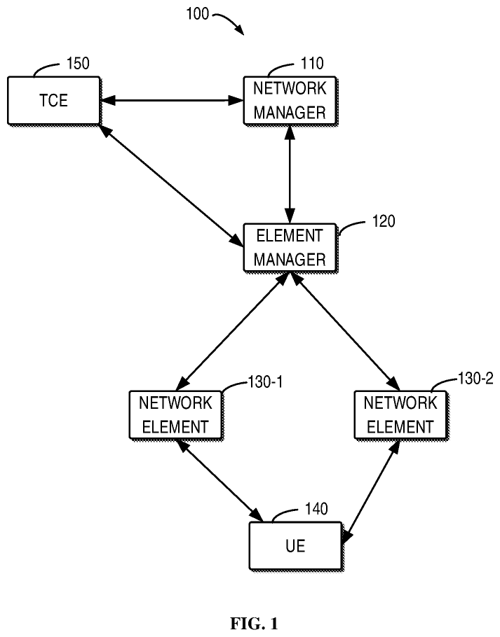

As mentioned above, in a conventional network management system, the Trace Integration Reference Point (IRP) manages and controls trace job from IRPManager in Network Manager (NM) to IRPAgent in Element Managers (EM). FIG. 1 shows a conventional network management system 100.

As shown in FIG. 1, a conventional network management system 100 comprises a network manager 110, an element manager 120, network elements 130-1 and 130-2. In this conventional network management system 100, the network manager 110 is considered as an IPRManager and the element manager 120 is considered as an IPRAgent. If the trace user 150 initiates a request for a service, the network elements 130-1 and 130-2 may be obtained the trace parameter from the network manager 110 and the element manager 120. Further, the trace parameter may be propagated between the signaling channel of the network elements 130-1 and 130-2. After generating the trace report in the network elements 130-1 or 130-2, the trace report is transmitted to the network manager 110 and the element manager 120. The trace user 150 may be obtained the trace report from the network manager 110 or the element manager 120.

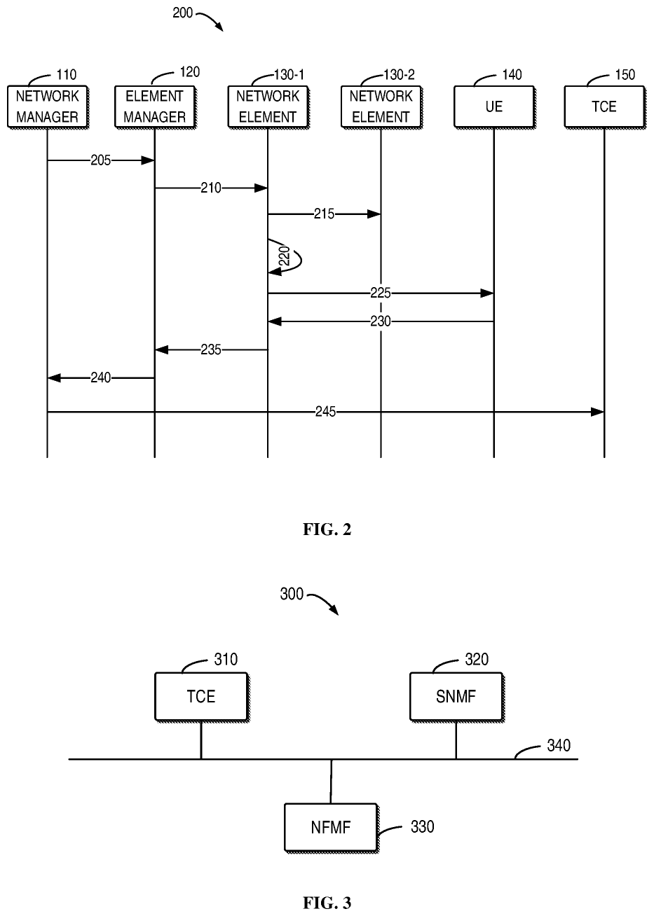

For example, FIG. 2 shows an example process 200 for trace management based on the conventional network management system of FIG. 1. As shown in FIG. 2, the network manager 110 activates 205 a Trace Job through TraceIRP between the network manager 110 and the element manager 120. Then the element manager 120 further activates 210 a Trace Session on a network element 130-1. The network element 130-1 may propagate 215 the Trace Session on another network element 130-2 through signal plane. At 220, the network element 130-1 starts a trace recording session once the trace recording session is triggered by specific event. The network element 130-1 may capture messages, decodes messages if required and save the trace records in a file. If immediate Minimization of Drive Tests (MDT) job type is included, the network element 130-1 may select 225 a UE 140 to configure MDT parameters in the UE 140. The UE 140 may report 230 MDT measurements based on MDT parameters to the network element 130-1. From 235 to 245, the network element 130-1 transfers the trace report to trace user 150 via the network manager 110 or the element manager 120 based on the configuration. Furthermore, the report may also be retrieved from the network manager 110, the element manager 120 and the trace user 150.

However, this specific interface and tightly coupled design pattern, as shown in FIGS. 1-2, is incompatible with Services Based Management Architecture (SBMA) management paradigm that 3GPP SA5 introduced for 5G management in 3GPP Release 15. The mechanism limited the management capability across multiple layers. In addition, although the current mechanism of the trace management is a smart way to convey trace management information on signaling plane, it also introduces complicity and potential security and availability issues.

Therefore, in the present disclosure, a new Network Resource Model (NRM) based trace management is introduced. The new model may simplify the architecture and interaction, and align with Service Based Management Architecture (SBMA) of Release 15. In the new method, trace session and supported classes will be defined in NRM as Managed Objects (MOs), and the trace control will be implemented with generic provisioning services such as creating IOC or getting/setting IOC Attributes.

FIG. 3 shows an example network management system 300 in which embodiments of the present disclosure may be implemented. The network management system 300 may be considered as a management layer over the communication networks. In some examples, the network management system 300 may be implemented as the 3rd Generation Partnership Project (3GPP) management system with network resource model (NRM).

As shown in FIG. 3, the system 300 may include a Trace Collection Entity (TCE) 310, a Subnetwork Management Function (SNMF) 320 and a Network Function Management Function (NFMF) 330. The TCE 310 can be considered as a network management entity for managing managed object instances (MOIs). In general, the network management entity may also be referred to as a network management function, element, device, apparatus, and the like. Specifically, TCP 310 may be referred to as a network optimization function, analytics function (such as Network Data Analytics Function (NWDAF) in 5G core network architecture) or an orchestration function.

As used herein, both SNMF 320 and NFMF 330 may be referred to Management Function which provide generic services for provisioning managed objects. A MOI is a logical representation of a virtual or physical network functions in a communication network. At the network management layer, information object classes (IOCs) may be defined, for example, with a Network Resource Model (NRM). The relationships between IOCs (including inheritance and name containment) and their attributes may also be defined. A MOI may be considered as an instance of the IOC and may sometimes be referred to as a managed object (MO) for short. The network management entity manages a set of MOIs that are instantiated from the IOCs defined in the NRM. A MOI may be corresponding to at least one of, for example, a Managed Function (MF) such as a 3GPP MF, a Managed Element (ME) such as a 3GPP ME, a sub-network of a communication network such as a 3GPP Sub-network and a managed object instance inherited from one of the Managed Function, the Managed Element and the sub-network.

As shown in FIG. 3, the TCP 310, the SNMF 320 and the NFMF 330 are connected with the bus 340 for the Generic Provisioning Management Service. In the system 300, the new IOCs are introduced in SA5 NRM for Trace Management. The MOs instantiated from the IOCs are provisioned through generic services provided by the related Management Functions. The consumer, such as TCE 310 in FIG. 3, can invoke createMOI service to create Trace Session, Trace Recording Session, Trace Report, Trace Record, etc. instances. The consumer can also invoke modifyMOIAttributes service to change the status or parameters of the Trace Session, and getMOIAttributes service to get status or parameters of Trace Session, Trace Recording Session, Trace Report, Trace Record, etc. The consumer can also terminate the trace by calling deleteMOI service.

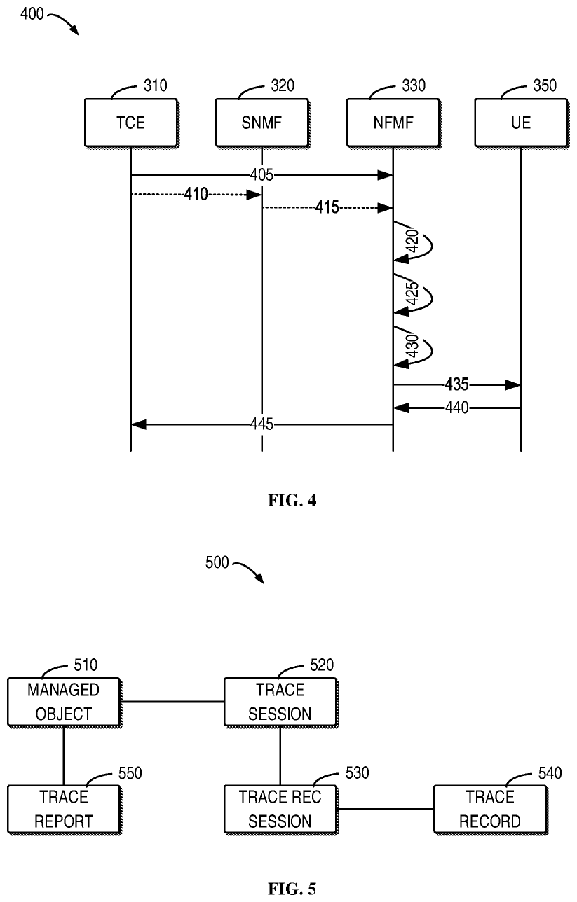

Principle and implementations of the present disclosure will be described below in detail with reference to FIG. 4, which shows a process 400 for trace management according to an embodiment of the present disclosure. For the purpose of discussion, the process 400 will be described with reference to FIG. 3. The process 400 may be implemented by the SNMF 320 or the NFMF 330 in FIG. 3.

As shown in FIG. 4, the TCE 310 may initiate a request for the Generic Provisioning Management Service. The TCE 310 transmits 405 the request for a trace session to the NFMF 330. For example, the trace session may be associated with at least one of the following: Subscriber and Equipment trace, Service Level Trace; Cell Traffic Trace; Minimization of Drive Test (MDT), Radio Link Failure (RLF), Radio Connection Establishment Failure, RCEF.

In some embodiments, the TCE 310 may also transmit 410 the request to the SNMF 320 to activate a trace session of a network slice subnet. The SNMF 320 may create a Trace Session Object (TSO) and set parameters from the TCE 310 on the TSO. Then the SNMF 320 may propagate 415 the trace session of constituted NFs and their attributes, and calls related NFMF, such as NFMF 320 to create and configure the TSO circularly.

The NFMF 330 determines 420 the trace session associated with the MOI of NFMF 330. In some embodiments, the NFMF 330 may create a Trace Session Object (TSO) based on the trace parameters obtained from the request. The trace parameters indicate attributes of the trace session.

In some embodiments, the trace parameters of a trace session can be configured on a MO through Generic Provisioning Services exposed by the MFNF 330 used to manage the containing MO of the TSO.

In some embodiments, the trace parameters of a trace session can be provided by a user or management entity, such as TCE 310, or propagated from the trace session of other Managed Object/s, such as SNMF 320.

In some embodiments, the TSO may be created, configured and activated when the corresponding trace session is required. The trace session may be associated with at least one of the following: Subscriber and Equipment trace, Service Level Trace; Cell Traffic Trace; MDT and RLF. Correspondingly, the TSO may be deactivated or deleted when those trace session is finished. When the TSO is created or deleted, a notification will be generated and reported to the TCE 310.

After receiving the request, if the NFMF 330 detects that an event occurs, the NFMF 330 generates 425 a trace recording session in the trace session. The trace recording session is associated with the trace session.

In some embodiments, the trace recording session creation is triggered by specific events when the containing TSO is activated and a trace recording session deletion is triggered by specific events when the containing TSO is activated. All trace recording session will be deleted after the containing TSO is deactivated. When the trace recording session object (TRSO) is created or deleted, a notification will be generated and reported to the TCE 310.

After the event occurs, signaling messages may be transmitted in the trace session. the NFMF 330 may capture a message and generate a trace record in the trace recording session. The trace record is associated with the trace recording session. As used herein, the term “trace message” can be considered as all signaling messages transmitted in the session. The term “trace message” can also be referred to the measurements or report related to MDT, RLF and RCEF.

In some embodiments, when the trace record is created or deleted, a notification will be generated and reported to the TCE 310. The trace record can be sent to or retrieve from Trace Record consumer, such as the TCE 310.

The NFMF 330 generates 430 a trace report based on the trace record, which is associated with the managed object instance. In some embodiments, the trace reports are generated or aggregated based on trace records associated with the TRSOs of the TSO of the MO.

In some embodiments, when the trace report is created or deleted, a notification will be generated and reported to the TCE 310. The trace report can be sent to or retrieve from Trace Record consumer, such as the TCE 310.

Still refer to FIG. 4, for example, if an MDT job type is included in the request, the NFMF 330 may select the related UE and send 435 the MDT parameters to the related UE 350.

The UE 350 may report 440 the result of measurements based on the measurement performed in the UE 350.

In some embodiments, if the NFMF 330 receives a request for retrieving the trace report from the TCE 310, the NFMF 330 may transmit 445 the trace report to the TCE 310. In some embodiments, the NFMF 330 may transmit 445 the report to the TCE 310 actively.

The method for trace management explained with reference to process 400 combines the Management and the Signaling based trace control to NFMF Based control, which means the NFMF can be consumed by either Management Node or Management Functions in Network Functions. In this way, the duty of the management plane and control/signalling plane will be separated and the architecture and interaction between management entities and network functions will be simplified.

FIG. 5 illustrates a diagram of class in the Network Resource Model based trace management. The managed object 510 as shown in FIG. 5 can be considered as a Subnetwork, Managed Function, Managed Element or managed object instance inherited from one of the Managed Function, the Managed Element and the sub-network.

As shown in FIG. 5, the trace session 520 is associated with the managed object 510 when the TSO is created. After the event is detected, a trace recording session object is created in the trace session object and the trace recording session 530 is associated with the trace session 520. Based on the captured message or MDT measurement or report, as described above, a trace record object is created and the trace record 540 is associated with the trace record session 530. A trace report may be generated based on the trace record and the trace report object is created. The trace report 550 is associated with the managed object 510.

The trace session 520, the trace record session 530 and the trace record 540 may be referred to as trace related IOC, which can be an abstract IOC or a concrete IOC. The trace related IOC can be inherited by others trace related sub-classes.

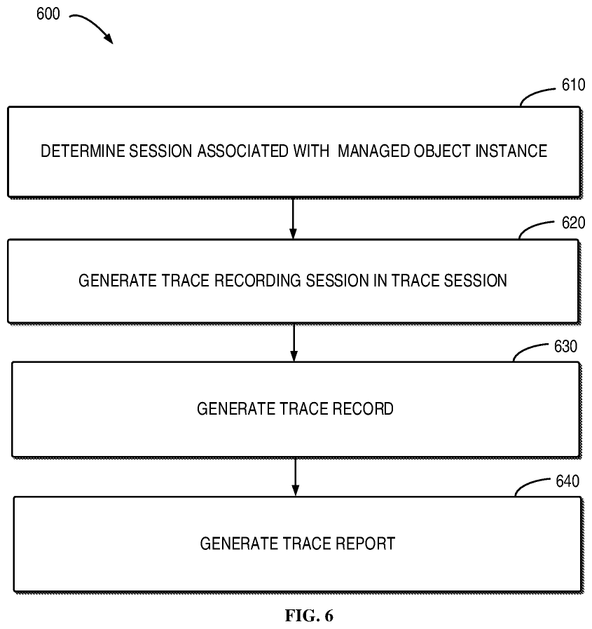

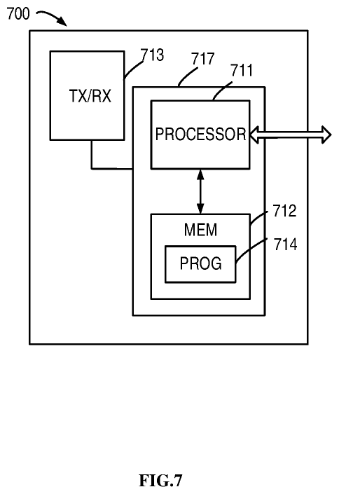

FIG. 6 shows a flowchart of an example method 600 for trace management according to some example embodiments of the present disclosure. The method 600 can be implemented at the NFMF 330 as shown in FIG. 3. For the purpose of discussion, the method 600 will be described with reference to FIG. 3.

At 610, on a managed object instance, if the NFMF 330 receives a request for a trace session from a trace user, the NFMF 330 determines the trace session associated with the managed object instance.

In some embodiments, the trace session is associated with at least one of the following: Subscriber and Equipment trace; Service Level Trace; Cell Traffic Trace; Minimization of Drive Test, MDT; Radio Link Failure, RLF and Radio Connection Establishment Failure, RCEF.

In some embodiments, the NFMF 330 may create a trace session object based on trace parameters obtained from the request, the trace parameters indicating attributes of the trace session.

At 620, the NFMF 330 generates a trace recording session in the trace session, the trace recording session indicating an event occurring after the request is received, the trace recording session being associated with the trace session.

At 630, the NFMF 330 generates a trace record at least partially based on trace message in the trace recording session, the trace message being a signal transmitted or terminal device measurement or report in the trace session, the trace record being associated with the trace recording session.

At 640, the NFMF 330 generates a trace report at least partially based on the trace record, the trace report being associated with the managed object instance.

In some embodiments, the NFMF 330 may also propagate trace parameters for a further trace session of a further managed object instance, the trace parameters indicating attributes of the trace session.

In some embodiments, the NFMF 330 may also transmit the trace report to the trace user, when the NFMF 330 received a request for retrieving the trace report from the trace user.

In some embodiments, the NFMF 330 may also transmit the trace report to the trace user actively and triggered by event.

In some embodiments, the NFMF 330 may report notification in a case of one of the followings: creating or deleting an object associated with the trace session; creating or deleting an object associated with the trace recording session; creating or deleting an object associated with the trace record; and creating or deleting an object associated with the trace report.

In some embodiments, the managed object instance corresponds to at least one of: a Managed Function; a Managed Element; a sub-network; and a managed object instance inherited from one of the Managed Function, the Managed Element and the sub-network.

In some example embodiments, an apparatus capable of performing the method 600 (for example, the NFMF 330) may comprise means for performing the respective steps of the method 600. The means may be implemented in any suitable form. For example, the means may be implemented in a circuitry or software module.

In some example embodiments, the apparatus comprises: means for on a managed object instance, in response to receiving a request for a trace session from a trace user, determining the trace session associated with the managed object instance; means for generating a trace recording session in the trace session, the trace recording session indicating an event occurring after the request is received, the trace recording session being associated with the trace session; and means for generating a trace record at least partially based on trace message in the trace recording session, the trace record being associated with the trace recording session; and means for generating a trace report at least partially based on the trace record, the trace report being associated with the managed object instance.

In some embodiments, the means for determining the trace session may further comprise means for creating a trace session object based on trace parameters obtained from the request, the trace parameters indicating attributes of the trace session.

In some embodiments, the apparatus may further comprise means for propagating trace parameters for a further trace session of a further managed object instance, the trace parameters indicating attributes of the trace session.

In some embodiments, the apparatus may further comprise means for in response to receiving a request for retrieving the trace report from the trace user, transmitting the trace report to the trace user.

In some embodiments, the apparatus may further comprise means for transmitting the trace report to the trace user actively.

In some embodiments, the apparatus may further comprise means for reporting notification in a case of one of the followings: creating or deleting an object associated with the trace session; creating or deleting an object associated with the trace recording session; creating or deleting an object associated with the trace record; and creating or deleting an object associated with the trace report.

FIG. 7 illustrates a simplified block diagram of a device 700 that is suitable for implementing embodiments of the present disclosure. The device 700 may be embodied as or comprised in the SNMF 320 or NFMF 330 shown in FIG. 3.

The apparatus 700 comprises at least one processor 711, such as a data processor (DP) and at least one memory (MEM) 712 coupled to the processor 711. The apparatus 700 may further include a transmitter TX and receiver RX 713 coupled to the processor 711, which may be operable to communicatively connect to other apparatuses. The MEM 712 stores a program or computer program code 714. The at least one memory 712 and the computer program code 714 are configured to, with the at least one processor 711, cause the apparatus 700 at least to perform in accordance with embodiments of the present disclosure, for example the process 400.

A combination of the at least one processor 711 and the at least one MEM 712 may form processing means 715 configured to implement various embodiments of the present disclosure.

Various embodiments of the present disclosure may be implemented by computer program executable by the processor 711, software, firmware, hardware or in a combination thereof.

The MEM 712 may be of any type suitable to the local technical environment and may be implemented using any suitable data storage technology, such as semiconductor based memory devices, magnetic memory devices and systems, optical memory devices and systems, fixed memory and removable memory, as non-limiting examples.

The processor 711 may be of any type suitable to the local technical environment, and may include one or more of general purpose computers, special purpose computers, microprocessors, digital signal processors (DSPs) and processors based on multicore processor architecture, as non-limiting examples.

Although some of the above descriptions on the GD based signal detection and staged signal detection are made in the context of a wireless communication system shown in FIG. 1, it should not be construed as limiting the spirit and scope of the present disclosure. The principle and concept of the present disclosure may be more generally applicable to other scenarios.

In addition, the present disclosure may also provide a carrier containing the computer program as mentioned above (e.g., computer instructions/grogram code 714 in FIG. 7). The carrier includes a computer readable storage medium and a transmission medium. The computer readable storage medium may include, for example, an optical compact disk or an electronic memory device like a RAM (random access memory), a ROM (read only memory), Flash memory, magnetic tape, CD-ROM, DVD, Blue-ray disc and the like. The transmission medium may include, for example, electrical, optical, radio, acoustical or other form of propagated signals, such as carrier waves, infrared signals, and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process 200 and/or the process 300 as described above with reference to FIGS. 2 and 3. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable media.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

For the purpose of the present disclosure as described herein above, it should be noted that,
method steps likely to be implemented as software code portions and being run using a processor at a network element or terminal (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the invention in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above, eNode-B etc. as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined apparatuses, or any one of their respective means) can be implemented as individual devices, units or means, but this does not exclude that they are implemented in a distributed fashion throughout the system, as long as the functionality of the device, unit or means is preserved;
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

It is noted that the embodiments and examples described above are provided for illustrative purposes only and are in no way intended that the present disclosure is restricted thereto. Rather, it is the intention that all variations and modifications be included which fall within the spirit and scope of the appended claims.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

Various embodiments of the techniques have been described. In addition to or as an alternative to the above, the following examples are described. The features described in any of the following examples may be utilized with any of the other examples described herein.

1. A method for trace management, comprising:
on a managed object instance, in response to receiving a request for a trace session from a trace user, determining the trace session associated with the managed object instance;
generating a trace recording session in the trace session, the trace recording session indicating an event occurring after the request is received, the trace recording session being associated with the trace session;
generating a trace record at least partially based on a trace message in the trace recording session, the trace record being associated with the trace recording session; and
generating a trace report at least partially based on the trace record, the trace report being associated with the managed object instance.

2. The method of claim 1, wherein the trace session is associated with at least one of the following:
Subscriber and Equipment trace;
Service Level Trace; Cell Traffic Trace;
Minimization of Drive Test, MDT;
Radio Link Failure, RLF; and
Radio Connection Establishment Failure, RCEF.

3. The method of claim 1, wherein determining the trace session comprises:
creating a trace session object based on trace parameters obtained from the request, the trace parameters indicating attributes of the trace session.

4. The method of claim 1, further comprising:
propagating trace parameters for a further trace session of a further managed object instance, the trace parameters indicating attributes of the trace session.

5. The method of claim 1, further comprising:
in response to receiving a request for retrieving the trace report from the trace user, transmitting the trace report to the trace user.

6. The method of claim 1, further comprising:
transmitting the trace report to the trace user actively.

7. The method of claim 1, further comprising:
reporting notification in a case of one of the following:
creating or deleting an object associated with the trace session;
creating or deleting an object associated with the trace recording session
creating or deleting an object associated with the trace record; and
creating or deleting an object associated with the trace report.

8. The method of claim 1, wherein the managed object instance corresponds to at least one of:
a Managed Function;
a Managed Element;
a sub-network; and
a managed object instance inherited from one of the Managed Function, the Managed Element and the sub-network.

9. An apparatus for trace management, comprising:
at least one processor; and
at least one memory including computer program codes;
the at least one memory and the computer program codes are configured to, with the at least one processor, cause the apparatus at least to:
on a managed object instance, in response to receiving a request for a trace session from a trace user, determining the trace session associated with the managed object instance;
generating a trace recording session in the trace session, the trace recording session indicating an event occurring after the request is received, the trace recording session being associated with the trace session;
generating a trace record at least partially based on a trace message in the trace recording session, the trace record being associated with the trace recording session; and
generating a trace report at least partially based on the trace record, the trace report being associated with the managed object instance.

10. The apparatus of claim 9, wherein the trace session is associated with at least one of the following:
Subscriber and Equipment trace;
Service Level Trace;
Cell Traffic Trace;
Minimization of Drive Test, MDT;
Radio Link Failure, RLF; and
Radio Connection Establishment Failure, RCEF.

11. The apparatus of claim 9, wherein the apparatus is caused to determine the trace session by:
creating a trace session object based on trace parameters obtained from the request, the trace parameters indicating attributes of the trace session.

12. The apparatus of claim 9, wherein the apparatus is further caused to:
propagate trace parameters for a further trace session of a further managed object instance, the trace parameters indicating attributes of the trace session.

13. The apparatus of claim 9, wherein the apparatus is further caused to:
in response to receiving a request for retrieving the trace report from the trace user, transmit the trace report to the trace user.

14. The apparatus of claim 9, wherein the apparatus is further caused to:
transmit the trace report to the trace user actively.

15. The apparatus of claim 9, wherein the apparatus is further caused to:
report notification in a case of one of the following:
creating or deleting an object associated with the trace session;
creating or deleting an object associated with the trace recording session
creating or deleting an object associated with the trace record; and
creating or deleting an object associated with the trace report.

16. The apparatus of claim 9, wherein the managed object instance corresponds to at least one of:
a Managed Function,
a Managed Element, a sub-network, and
a managed object instance inherited from one of the Managed Function, the Managed Element and the sub-network.

17. (canceled)

18. A non-transitory computer readable medium comprising program instructions for causing an apparatus to perform at least:
on a managed object instance, in response to receiving a request for a trace session from a trace user, determining the trace session associated with the managed object instance;
generating a trace recording session in the trace session, the trace recording session indicating an event occurring after the request is received, the trace recording session being associated with the trace session;
generating a trace record at least partially based on a trace message in the trace recording session, the trace record being associated with the trace recording session; and
generating a trace report at least partially based on the trace record, the trace report being associated with the managed object instance.

19. The non-transitory computer readable medium of claim 18, wherein the program instructions for causing the apparatus to determine the trace session comprise program instructions for causing the apparatus to perform:
creating a trace session object based on trace parameters obtained from the request, the trace parameters indicating attributes of the trace session.

20. The non-transitory computer readable medium of claim 18, wherein the program instructions further cause the apparatus to:
propagate trace parameters for a further trace session of a further managed object instance, the trace parameters indicating attributes of the trace session.

21. The non-transitory computer readable medium of claim 18, wherein the program instructions further cause the apparatus to:
in response to receiving a request for retrieving the trace report from the trace user, transmit the trace report to the trace user.
